(19) United States
(12) Patent Application Publication
(10) Pub. No.: US 2015/0067110 A1
(43) Pub. Date: Mar. 5, 2015

(54) Media Playing Method, Apparatus, and System

(71) Applicant: Huawei Technologies Co., Ltd., Shenzhen (CN)

(72) Inventors: Yuqing Zhao, Hangzhou (CN); Guangzhu Zeng, Hangzhou (CN)

(21) Appl. No.: 14/536,850

(22) Filed: Nov. 10, 2014

Related U.S. Application Data
(63) Continuation of application No. PCT/CN2012/088103, filed on Dec. 31, 2012.

(30) Foreign Application Priority Data
May 10, 2012 (CN) 201210143499.2

(51) Int. Cl. H04L 29/06; H04L 29/08

(52) U.S. Cl. CPC H04L 65/60; H04L 67/06
USPC 709/219

(57) ABSTRACT

A media playing method is provided. The method includes separately sending a connection preparation message to a media server and at least one media renderer that supports multicast, so as to instruct the media server and each media renderer to configure a multicast protocol address according to the connection preparation message; and sending a media transport identifier and a play message to the media server, so as to instruct the media server to transmit, on the multicast protocol address according to the play message, a media stream of a to-be-played media file identified by the media transport identifier, so that each media renderer receives the media stream on the multicast protocol address and plays the to-be-played media file locally.

### CROSS-REFERENCE TO RELATED APPLICATIONS

This application is a continuation of International Application No. PCT/CN2012/088103, filed on Dec. 31, 2012, which claims priority to Chinese Patent Application No. 201210143499.2, filed on May 10, 2012, both of which are hereby incorporated by reference in their entireties.

### TECHNICAL FIELD

The present invention relates to communications technologies, and in particular, to a media playing method, apparatus, and system.

### BACKGROUND

The Digital Living Network Alliance (DLNA) defines a set of standard solutions for facilitating digital home entertainment and living of people. In media playing and sharing, a digital media server (DMS), a digital media controller (DMC), a digital media player (DMP), and a digital media renderer (DMR) are involved. The DMS is configured to store and manage media resources, so that another device may acquire media content conveniently through a network. The DMC is configured to browse media information of the DMS, acquire metadata information of media from the DMS, and instruct the DMR to play selected media content. The DMR is a media player that does not have a DMC function, whereas the DMP is a media player that has a DMC function.

FIG. 1 is a schematic structural diagram of a DLNA three-box interaction model in the prior art. As shown in FIG. 1, the three-box interaction model in the prior art is composed of a DMS, a DMR, and a DMC. The DMC obtains device information of the DMS and the DMR by using a DLNA/universal plug and play protocol (UPnP) device automatic discovery protocol, where the device information is used to describe a service list provided on each device. A content directory service (CDS) is one of services therein. By using a browse or search command of the CDS (namely, CDS::browse or CDS::search), the DMC acquires media content information in the DMS and other related information for playing media content. When the DMC requests the DMR to play a piece of media content, the DMC sends related information of the media content to the DMR, so that the DMR can correctly complete playing.

However, the existing DLNA technology provides only a unicast transport and playing technology and cannot implement synchronous playing, by multiple players, of same media content, that is, implementing synchronous video playing, synchronous photo pushing and sharing, and the like in different areas of a home.

### SUMMARY

Embodiments of the present invention provide a media playing method, apparatus, and system to implement synchronous playing of same media content by multiple players.

A first aspect of embodiments of the present invention provides a media playing method, including separately sending a connection preparation message to a media server and at least one media renderer that supports multicast, so as to instruct the media server and each media renderer to configure a multicast protocol address according to the connection preparation message; and sending a media transport identifier and a play message to the media server, so as to instruct the media server to transmit, on the multicast protocol address according to the play message, a media stream of a to-be-played media file identified by the media transport identifier, so that each media renderer receives the media stream on the multicast protocol address and plays the to-be-played media file locally.

Another aspect of embodiments of the present invention provides another media playing method, including receiving a connection preparation message sent by a media controller, and configuring a multicast protocol address according to the connection preparation message; and receiving a media transport identifier and a play message that are sent by the media controller, and transmitting, on the multicast protocol address according to the play message, a media stream of a to-be-played media file identified by the media transport identifier, so that at least one media renderer supporting multicast separately receives the media stream on the multicast protocol address and plays the to-be-played media file locally.

Still another aspect of embodiments of the present invention provides still another media playing method, including receiving a connection preparation message sent by a media controller, and configuring a multicast protocol address according to the connection preparation message; and receiving a media stream of a to-be-played media file on the multicast protocol address, and playing the to-be-played media file locally; where the media stream of the to-be-played media file is transmitted on the multicast protocol address after a media server receives a media transport identifier and a play message that are sent by the media controller, and the to-be-played media file is identified by the media transport identifier.

Still another aspect of embodiments of the present invention provides a media controller, including a connection instructing module configured to separately send a connection preparation message to a media server and at least one media renderer that supports multicast, so as to instruct the media server and each media renderer to configure a multicast protocol address according to the connection preparation message; and a play instructing module configured to send a media transport identifier and a play message to the media server, so as to instruct the media server to transmit, on the multicast protocol address according to the play message, a media stream of a to-be-played media file identified by the media transport identifier, so that each media renderer receives the media stream on the multicast protocol address and plays the to-be-played media file.

Still another aspect of embodiments of the present invention provides a media server, including a first receiving module configured to receive a connection preparation message sent by a media controller, and configure a multicast protocol address according to the connection preparation message; a second receiving module configured to receive a media transport identifier and a play message that are sent by the media controller; and a sending module configured to transmit, on the multicast protocol address according to the play message, a media stream of a to-be-played media file identified by the media transport identifier, so that at least one media renderer supporting multicast separately receives the media stream on the multicast protocol address and plays the to-be-played media file locally.

Still another aspect of embodiments of the present invention provides a media renderer, including a fourth receiving module configured to receive a connection preparation message sent by a media controller, and configure a multicast protocol address according to the connection preparation message; and a playing module configured to receive a media stream of a to-be-played media file on the multicast protocol address, and play the to-be-played media file locally; where the media stream of the to-be-played media file is transmitted on the multicast protocol address after a media server receives a media transport identifier and a play message that are sent by the media controller, and the to-be-played media file is identified by the media transport identifier.

Still another aspect of embodiments of the present invention provides a media player, including the foregoing media controller and media renderer.

Still another aspect of embodiments of the present invention provides a media playing system, including the foregoing media controller, media server, and at least one media renderer.

The embodiments of the present invention have the following technical effects. A connection preparation message is sent to a media server and at least one media player separately, so that the media server and each media player configure a multicast protocol address; then a media transport identifier and a play message are sent to the media server, so as to instruct the media server to transmit a media stream of a to-be-played media file on the multicast protocol address, and each media player receives the media stream on the multicast protocol address and plays the to-be-played media file locally on each media player. The embodiments implement synchronous playing, by multiple players, of same media content, without the need of using a manner of requesting by multiple media players one by one, thereby saving network bandwidth for transmitting a media stream.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. Apparently, the accompanying drawings in the following description show some embodiments of the present invention, and a person of ordinary skill in the art may still derive other drawings from these accompanying drawings without creative efforts.

FIG. 1 is a schematic structural diagram of a DLNA three-box interaction model in the prior art;

FIG. 2 is a flowchart of a first embodiment of a media playing method according to the present invention;

FIG. 3 is a schematic diagram of network element interaction in the first embodiment of the media playing method according to the present invention;

FIG. 4 is a flowchart of a second embodiment of a media playing method according to the present invention;

FIG. 5 is a flowchart of a third embodiment of a media playing method according to the present invention;

FIG. 6A and FIG. 6B are a signaling flowchart of a fourth embodiment of a media playing method according to the present invention;

FIG. 7 is a schematic structural diagram of a first embodiment of a media controller according to the present invention;

FIG. 8 is a schematic structural diagram of a second embodiment of a media controller according to the present invention;

FIG. 9 is a schematic structural diagram of a first embodiment of a media server according to the present invention;

FIG. 10 is a schematic structural diagram of a second embodiment of a media server according to the present invention;

FIG. 11 is a schematic structural diagram of a first embodiment of a media renderer according to the present invention; and

FIG. 12 is a schematic structural diagram of a second embodiment of a media renderer according to the present invention.

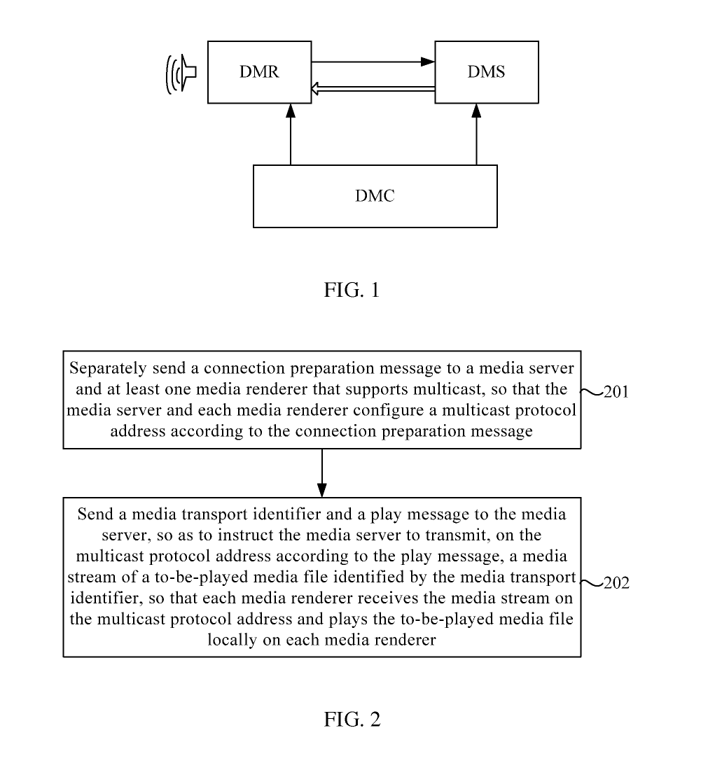

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. The described embodiments are a part rather than all of the embodiments of the present invention. All other embodiments obtained by a person of ordinary skill in the art based on the embodiments of the present invention without creative efforts shall fall within the protection scope of the present invention.

FIG. 2 is a flowchart of a first embodiment of a media playing method according to the present invention. As shown in FIG. 2, this embodiment provides a media playing method. This embodiment describes the solution of the present invention from a perspective of a media controller, which may include the following steps.

Step 201: Separately send a connection preparation message to a media server and at least one media renderer that supports multicast, so that the media server and each media renderer configure a multicast protocol address according to the connection preparation message.

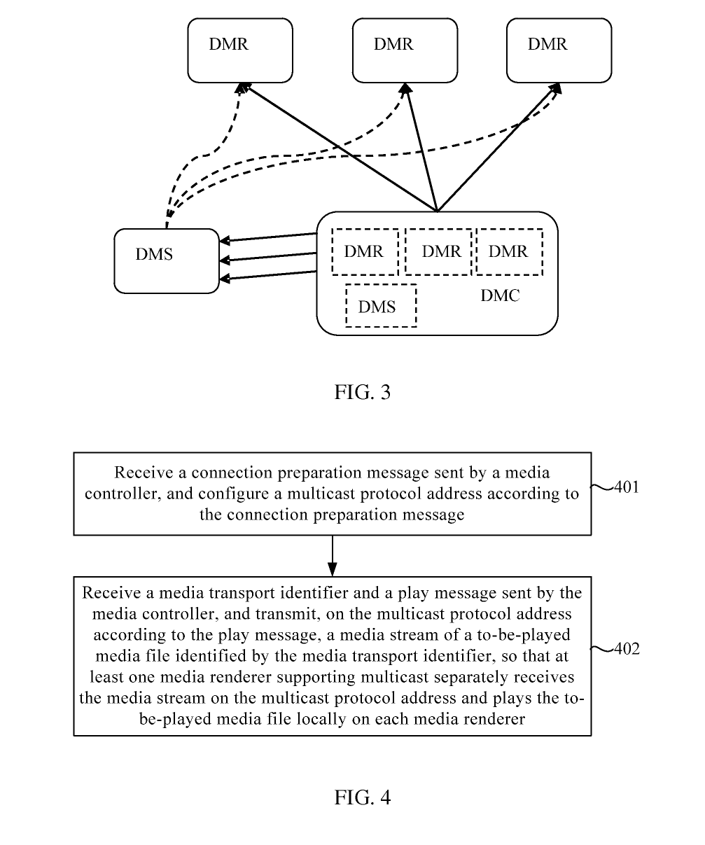

In this embodiment, the media controller may be a DMC or a mobile digital media controller (M-DMC), the media server may be a DMS or a mobile digital media server (M-DMS), and the media renderer may be a DMR or a DMP. This embodiment is an improvement in a media playing solution of a DLNA three-box model in the prior art and is not limited to a single DMC, DMS, and DMR network element. In this embodiment, there may be more than one DMR. FIG. 3 is a schematic diagram of network element interaction in the first embodiment of the media playing method according to the present invention. As shown in FIG. 3, in this embodiment, multiple DMRs are disposed in a local network, and the multiple DMRs may synchronously play a same media file under control of a DMC. In this embodiment, all the network elements DMC, DMS, and DMR are capable of interconnecting and interworking with each other in a same broadcast domain of the local network, and are capable of receiving or sending a multicast packet. Physical connections between the network elements are not limited to an Ethernet interface, and the network elements may also be connected by using wireless fidelity (WiFi), power line communication (PLC), or Next Generation Home entertainment network (G.hn).

This step is that the media controller sends a connection preparation message to the media server and the media server prepares a media transport connection after receiving the connection preparation message. A transport address may be configured as a multicast protocol address according to the connection preparation message, and subsequently, the media server transmits a related media stream on the multicast protocol address. The media controller further separately sends a connection preparation message to at least one media renderer that supports multicast. Each media renderer prepares a media transport connection after receiving the connection preparation message. A transport address may be configured as a multicast protocol address according to the connection preparation message, and subsequently, each media renderer receives a media stream on the multicast protocol address.

Step 202: Send a media transport identifier and a play message to the media server, so as to instruct the media server to transmit, on the multicast protocol address according to the play message, a media stream of a to-be-played media file identified by the media transport identifier, so that each media renderer receives the media stream on the multicast protocol address and plays the to-be-played media file locally.

After the media server and each media renderer complete preparations of media transport connections, the media controller sends a media transport identifier and a play message to the media server, and instructs, by using the play message, the media server to transmit the media stream of the to-be-played media file on the multicast protocol address. The to-be-played media file is a media file identified by the media transport identifier. It may be that a user selects, by using a display interface of the media controller, a media file that needs to be played, and the media controller generates a media transport identifier according to the selection of the user. After receiving the play message, the media server transmits the media stream of the to-be-played media file on the previously acquired multicast protocol address. Each media renderer receives the media stream on the previously acquired multicast protocol address. After receiving the media stream, each media renderer may play the to-be-played media file locally, thereby achieving an effect of synchronously playing same-source media at multiple points.

Further, the media playing method provided by this embodiment may further include the following step. Acquire device information of the media server and the media renderer through a device automatic discovery process, where the device information includes service information of all services that are supported by the media server and the media renderer. Before playing the media, the media controller needs to acquire device information of the media server and each media renderer through the device automatic discovery process, where the device information includes service information of all services that are supported by each device. Herein the service information may be a uniform resource locator to service description (SCPDURL) corresponding to each service, a uniform resource locator for control (controlURL), and a uniform resource locator for eventing (eventSubURL). A uniform resource locator (URL) specified by the SCPDURL defines a capability set of the service, which includes a service state table (serviceStateTable) and an action list (actionList). The serviceStateTable includes all internal state variables of the service, and the actionList describes an action interface provided by the service for an external system. The controlURL defines a target URL when a control point (CP) of the service submits an Action, and a service subsystem where the URL is located is responsible for executing the Action. The eventSubURL defines a URL for subscribing to an eventing. In this embodiment, services supported by the media server include a CDS, a connection management service (CMS), and an audio video transport service (AVTS), and the CDS service needs to support a browse action or a search action. A service supported by the media renderer includes a CMS, and an AVTS and a rendering control service (RCS) may also be supported.

The connection preparation message sent by the media controller in step 201 in this embodiment may be PrepareForConnection in the CMS service, that is, the DMC commands, by using CM:: PrepareForConnection, the DMS to prepare a media transport connection and commands, by using CM:: PrepareForConnection, each DMR to prepare a media transport connection. The media transport identifier and the play message that are sent by the media controller in step 202 in this embodiment may be SetAVTransportURI and Play in the AVTS service, that is, the DMC commands, by using AVT:: SetAVTransportURI and AVT::Play, the DMS to start to send, through a multicast media transport protocol, the media stream of the to-be-played media file that has been streamed.

This embodiment provides a media playing method, in which a connection preparation message is sent to a media server and at least one media renderer separately, so that the media server and each media renderer configure a multicast protocol address; then a media transport identifier and a play message are sent to the media server, so as to instruct the media server to transmit a media stream of a to-be-played media file on the multicast protocol address, so that each media renderer receives the media stream on the multicast protocol address and plays the to-be-played media file locally. Because the media renderer in this embodiment is included in a media player, this embodiment implements synchronous playing, by multiple players, of same media content, without the need of using a manner of requesting by multiple media players one by one, thereby causing no waste of resources.

FIG. 4 is a flowchart of a second embodiment of a media playing method according to the present invention. As shown in FIG. 4, this embodiment provides a media playing method. This embodiment describes the solution of the present invention from a perspective of a media server, which may include the following steps.

Step 401: Receive a connection preparation message sent by a media controller, and configure a multicast protocol address according to the connection preparation message.

This step is that a media server receives a connection preparation message sent by the media controller, and the media server prepares a media transport connection after receiving the connection preparation message. A transport address may be configured as a multicast protocol address according to the connection preparation message, and subsequently, the media server transmits a related media stream on the multicast protocol address.

Step 402: Receive a media transport identifier and a play message sent by the media controller, and transmit, on the multicast protocol address according to the play message, a media stream of a to-be-played media file identified by the media transport identifier, so that at least one media renderer supporting multicast separately receives the media stream on the multicast protocol address and plays the to-be-played media file locally.

After the media server completes the preparation of the media transport connection, the media server continues to receive the media transport identifier and the play message that are sent by the media controller, and the media server transmits, according to the play message, the media stream of the to-be-played media file on the multicast protocol address. The to-be-played media file is a media file identified by the media transport identifier. It may be that a user selects, by using a display interface of the media controller, a media file that needs to be played, and the media controller generates a media transport identifier according to the selection of the user. After receiving the play message, the media server transmits the media stream of the to-be-played media file on the previously acquired multicast protocol address. Each media renderer receives the media stream on the previously acquired multicast protocol address. After receiving the media stream, each media renderer may play the to-be-played media file locally, thereby achieving an effect of synchronously playing same-source media at multiple points. The media renderer in this step is a media renderer that is selected by the user and supports multicast.

Further, the media playing method provided by this embodiment may further include the following steps. The media server receives a play control message sent by the media controller; and the media server controls play progress and a play speed of the to-be-played media file according to the play control message.

This embodiment provides a media playing method, in which a multicast protocol address is configured according to a received connection preparation message, a media stream of a to-be-played media file is transmitted on the multicast protocol address according to a received play message, each media renderer receives the media stream on the multicast protocol address, and plays the to-be-played media file locally. This embodiment implements synchronous playing, by multiple players, of same media content, without the need of using a manner of requesting by multiple media players one by one, thereby causing no waste of resources.

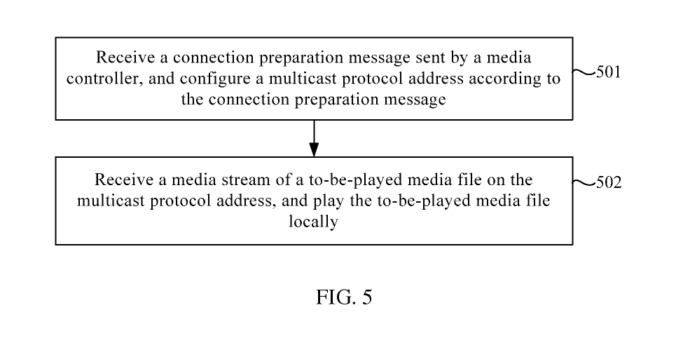

FIG. 5 is a flowchart of a third embodiment of a media playing method according to the present invention. As shown in FIG. 5, this embodiment provides a media playing method. This embodiment describes the solution of the present invention from a perspective of a media renderer, which may include the following steps.

Step 501: Receive a connection preparation message sent by a media controller, and configure a multicast protocol address according to the connection preparation message.

This step is that a media renderer receives a connection preparation message sent by the media controller and the media renderer prepares a media transport connection after receiving the connection preparation message. A transport address may be configured as a multicast protocol address according to the connection preparation message, and subsequently, the media renderer receives a media stream on the multicast protocol address.

Step 502: Receive a media stream of a to-be-played media file on the multicast protocol address, and play the to-be-played media file locally.

This step is that the media renderer receives the media stream on the previously acquired multicast protocol address and, after receiving the media stream, the media renderer may play the to-be-played media file locally, thereby achieving an effect of synchronously playing same-source media at multiple points. The media stream of the to-be-played media file is transmitted on the multicast protocol address after a media server receives a media transport identifier and a play message that are sent by the media controller, and the to-be-played media file is identified by the media transport identifier. It may be that a user selects, by using a display interface of the media controller, a media file that needs to be played, and the media controller generates a media transport identifier according to the selection of the user. The media renderer in this step is a media renderer that is selected by the user and supports multicast.

Further, the media playing method provided by this embodiment may further include the following steps. After receiving the connection preparation message, the media renderer checks whether a media transport protocol of the media server, which is acquired by the media controller, is a multicast media transport protocol, that is, checks whether the media controller supports the multicast media transport protocol. If the media transport protocol of the media server is the multicast media transport protocol, the media renderer joins a multicast address group identified by the multicast protocol address.

Further, the media playing method provided by this embodiment may further include the following steps. The media renderer receives an effect control message sent by the media controller; and the media renderer controls a play effect of the to-be-played media file according to the effect control message.

This embodiment provides a media playing method, in which a multicast protocol address is configured according to a received connection preparation message, a media stream of a to-be-played media file is received on the multicast protocol address, and the to-be-played media file is played locally, where the media stream of the to-be-played media file is transmitted on the multicast protocol address after a media server receives a media transport identifier and a play message that are sent by a media controller, and the to-be-played media file is identified by the media transport identifier. This embodiment implements synchronous playing, by multiple players, of same media content, without the need of using a manner of requesting by multiple media players one by one, thereby causing no waste of resources.

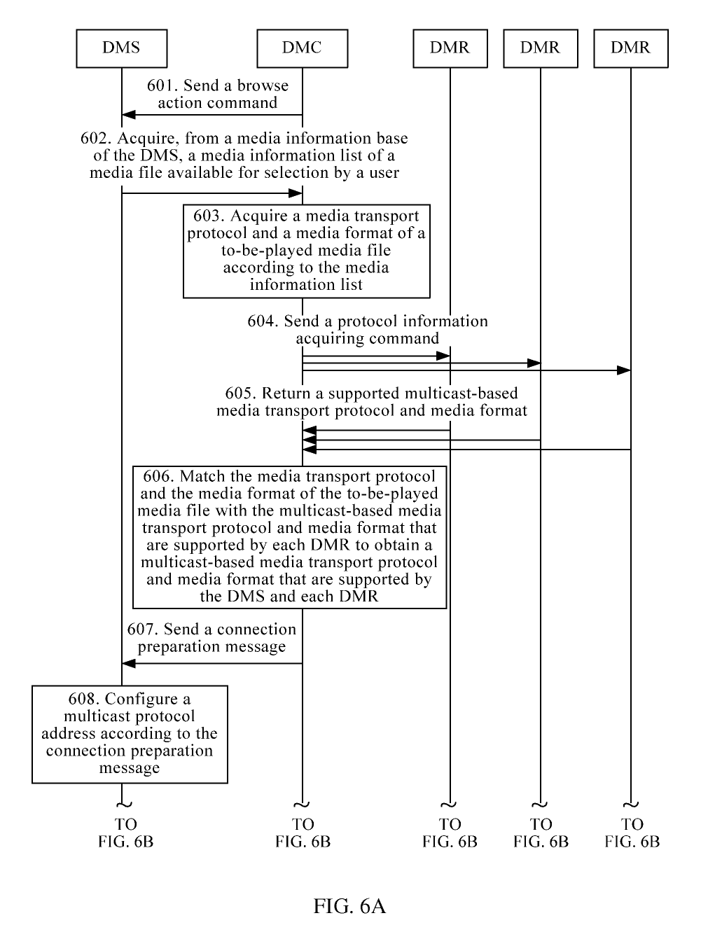

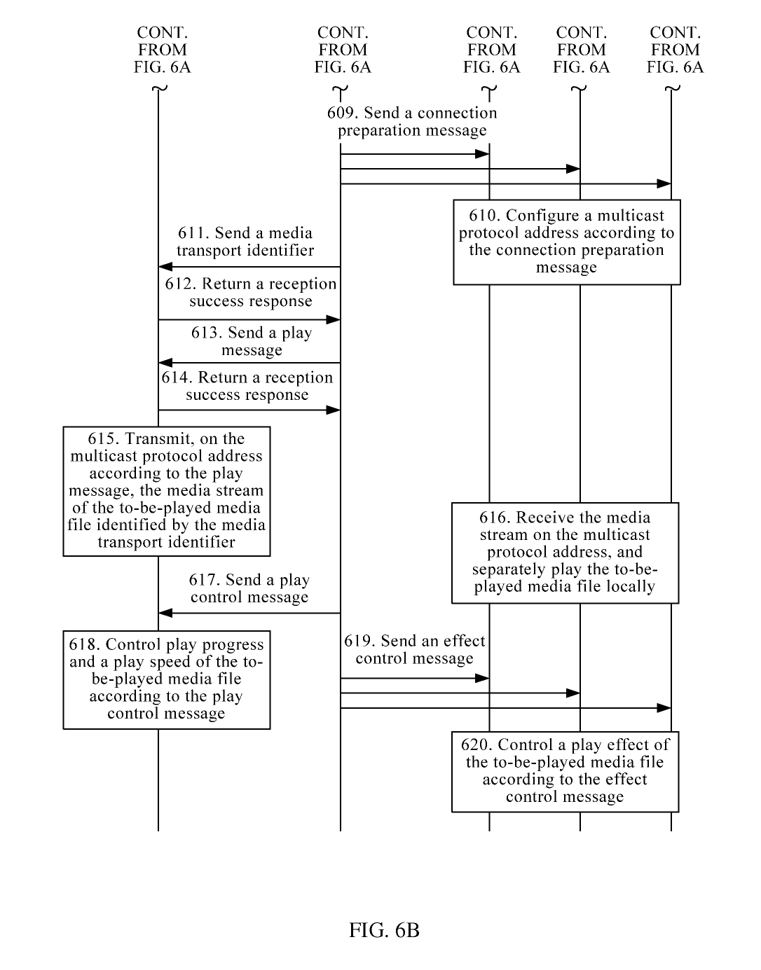

FIG. 6A and FIG. 6B are a signaling flowchart of a fourth embodiment of a media playing method according to the present invention. As shown in FIG. 6A and FIG. 6B, this embodiment provides a media playing method. In this embodiment, a media controller is a DMC, a media server is a DMS, and a media renderer is a DMR. In this embodiment, services supported by the DMS include a CDS, a CMS, and an AVTS, and the CDS service needs to support a Browse Action; a service supported by the DMR includes a CMS, and an AVTS and an RCS may also be supported. This embodiment may include the following steps.

Step 601: A DMC sends a browse action command to a DMS.

In this embodiment, before the DMC controls playing, by the DMS, of a media file, the DMC first sends the browse action command to the DMS. The browse action command in this embodiment may be Browse in a CDS service.

Step 602: The DMC acquires, from a media information base of the DMS, a media information list of a media file available for selection by a user.

After receiving the browse action command, the DMS may return the media information base of the DMS to the DMC. The DMC may acquire, from the media information base of the DMS, the media information list of the media file available for selection by the user. Each media information entry in the media information list includes a media transport protocol and a media format of each media file. In this embodiment, when the DMS generates a media information entry in the media information base, each media file may correspond to multiple media information entries, that is, each media file may include multiple media transport protocols and media formats. In this embodiment, at least one media information entry of a multicast media transport protocol needs to be generated for each media file. In this embodiment, the DMC may browse the media information base of the DMS by using CDS::Browse, thereby displaying, on a display interface, all media information lists available for selection by the user. Or, the DMC may also search the media information base of the DMS by using CDS::Search, thereby directly displaying, on the display interface, a media information list that is found in the media information base and is available for selection by the user.

In this embodiment, media content information in the media information base of the DMS is generated by the DMS for each media file by using the CDS service. At least one media information entry may be generated for a same media file, and each media information entry defines a manner of accessing a media source. In this embodiment, the media information entry may be marked with Res. For a program “/sdcard/media/If You Are The One.mpeg”, a media information entry generated by the DMS for the program by using the CDS may be as follows:

<res protocolInfo=“http-get:*:video/mpeg:*”>
http://192.168.1.2:8080/wishb-dms/media/If You Are The
One.mpeg</res>
<res protocolInfo=“rtsp-RTP-UDP:*:video/x-ms-wmv:*”>
rtsp://192.168.1.2:554/wishb-dms/media/If You Are The One.wmv</res>

The protocolInfo is formed of the following strings: <protocol>:<network>:<contentFormat>:<additionalInfo>. The protocol defines a transport protocol for a streaming media client to acquire streaming media content, and the contentFormat defines key information such as a media format.

Step 603: The DMC acquires a media transport protocol and a media format of a to-be-played media file according to the media information list.

In this embodiment, the user may select, by using the display interface, a media file requiring synchronous playing at multiple points, that is, the to-be-played media file. The DMC may acquire the media transport protocol and the media format of the to-be-played media file according to a media information entry corresponding to the to-be-played media file in the media information list. In this embodiment, the DMS is required to support transmission of media content of the media file through the multicast media transport protocol.

Step 604: The DMC separately sends a protocol information acquiring command to at least one DMR selected by the user.

In this embodiment, the user may select multiple DMRs to synchronously play the to-be-played media file. This step is that the DMC separately sends the protocol information acquiring command to at least one DMR selected by the user. The protocol information acquiring command in this embodiment may be GetProtocolInfo in the CMS service.

Step 605: Each DMR returns a multicast-based media transport protocol and media format that are supported by each DMR to the DMC.

After each DMR receives the protocol information acquiring command of the DMC, each DMR returns the multicast-based media transport protocol and media format that are supported by each DMR to the DMC. The DMC may acquire, by using CM::GetProtocolInfo, the multicast-based media transport protocol and media format that are supported by each DMR, where one DMR may support multiple media transport protocols and media formats. In this embodiment, each DMR is required to support the multicast media transport protocol. Herein the multicast media transport protocol may be a Real-time Transport Protocol over User Datagram Protocol over multicast (RTP-UDP-mc), a HyperText Transfer Protocol streaming over User Datagram Protocol over multicast (httpu-mc), and the like. In this embodiment, protocol information acquired by the DMC from the DMR may be, for example, protocolInfo=“RTP-UDP-mc:224.0.0.xxx:video/h264:*”, or protocolInfo=“httpu-mc:224.0.0.xxx:video/h264:*”. An acquired media transport protocol of the DMR is a multicast media transport protocol RTP-UDP-mc or httpu-mc, where the multicast protocol address is 224.0.0.xxx/24, that is, a media stream is transmitted by multicast only in a local network.

Step 606: The DMC matches the media transport protocol and the media format of the to-be-played media file with the multicast-based media transport protocol and media format that are supported by each DMR to obtain a multicast-based media transport protocol and media format that are supported by the DMS and each DMR.

After the media transport protocol and the media format of the to-be-played media file and the multicast-based media transport protocol and media format that are supported by each DMR are acquired, matching is performed according to the media transport protocol and the media format of the to-be-played media file and the multicast-based media transport protocol and media format that are supported by each DMR, so as to obtain an optimum media transport protocol and media format. Herein the optimum media transport protocol and media format are a multicast-based media transport protocol and media format that are supported by the DMS and each DMR. In this embodiment, the preferred optimum media transport protocol is a multicast media transport protocol, and at least one DMR supporting multicast is acquired. When none of the DMRs support the multicast media transport protocol, the user is prompted with a play failure.

Step 607: The DMC sends a connection preparation message to the DMS.

The connection preparation message in this embodiment may be PrepareForConnection in a CMS. This step may be that the DMC commands, by using CM::PrepareForConnection, the DMS to prepare a media transport connection.

Step 608: The DMS configures a multicast protocol address according to the connection preparation message.

After receiving the connection preparation message sent by the DMC, the DMS prepares a media transport connection according to the connection preparation message and configures a transport address as a multicast protocol address. For example, the DMS prepares a multicast protocol address of RTP-UDP-mc:224.0.0.xxx or httpu-mc:224.0.0.xxx to establish a media transport connection.

Step 609: The DMC sends a connection preparation message to each DMR.

The connection preparation message in this embodiment may be PrepareForConnection in the CMS. This step may be that the DMC commands, by using CM::PrepareForConnection, each DMR supporting multicast to prepare a media transport connection.

Step 610: Each DMR configures a multicast protocol address according to the connection preparation message.

After receiving the connection preparation message sent by the DMC, each DMR prepares a media transport connection according to the connection preparation message and configures a transport address as a multicast protocol address. For example, each DMR prepares a multicast protocol address of RTP-UDP-mc:224.0.0.xxx or httpu-mc:224.0.0.xxx to receive a media stream.

Step 611: The DMC sends a media transport identifier to the DMS.

This step is that the DMC sends a media transport identifier to the DMS, where the media transport identifier is used to identify the to-be-played media file and may be SetAVTransportURI in an AVTS service. This step may be that the DMC notifies the DMS of the to-be-played media file by using AVT::SetAVTransportURI, that is, notifies the DMS of the media file that is selected by the user and needs to be played.

Step 612: The DMS returns a reception success response to the DMC.

After receiving the media transport identifier, the DMS may return a reception success response to the DMC, indicating that the media transport identifier sent by the DMC is sent successfully and that the DMS has acquired the to-be-played media file.

Step 613: The DMC sends a play message to the DMS.

This step is that the DMC sends a play message to the DMS, where the play message may be Play in the AVTS service. This step may be that the DMC instructs, by using AVT::Play, the DMS to play the to-be-played media file. Herein the playing is as follows. The DMS sends, through the multicast media transport protocol, a media stream of the to-be-played media file that has been streamed.

Step 614: The DMS returns a reception success response to the DMC.

After receiving the play message, the DMS may return a reception success response to the DMC, indicating that the play message sent by the DMC is sent successfully.

Step 615: The DMS transmits, on the multicast protocol address according to the play message, the media stream of the to-be-played media file identified by the media transport identifier.

The transmitting, by the DMS on the multicast protocol address according to the play message, the media stream of the to-be-played file identified by the media transport identifier may be, for example, transmitting, on 224.0.0.xxx, the media stream of the to-be-played media file identified by SetAVTransportURI.

Step 616: Each DMR receives the media stream on the multicast protocol address and plays the to-be-played media file locally.

Each DMR supporting multicast receives the media stream on the multicast protocol address and after receiving the media stream, locally plays the media stream in real time, thereby implementing synchronous playing of the same media file on the multiple DMRs.

Step 617: The DMC sends a play control message to the DMS.

In this embodiment, in the process of synchronously playing same-source media at multiple points, the DMC may further perform synchronous control over the media file played on the multiple DMRs. Herein the control may be controlling a play process and play progress of the media file, including stop, pause, start, seek, and the like. This step is that the DMC sends a play control message to the DMS, where the play control message may be Stop, Pause, Start, and Seek in the AVTS service.

Step 618: The DMS controls play progress and a play speed of the to-be-played media file according to the play control message.

After receiving the play control message sent by the DMC, the DMS controls the play progress and the play speed of the to-be-played media file according to the play control message. In this embodiment, the DMC controls, by using commands such as AVT:: (Stop, Pause, Start, and Seek), performing uniform control, by the DMS, over the play progress, the play speed, and the like of the media file played on each DMR, such as play stop and play pause.

Step 619: The DMC sends an effect control message to each DMR.

In this embodiment, the DMC may not only perform uniform control over the play progress of the media file, but also uniformly control a play effect of the media file. This step is as follows. The DMC sends an effect control message to each DMR, where the effect control message may be SetVolume, SetBrightness, and the like in an RCS service.

Step 620: The DMR controls a play effect of the to-be-played media file according to the effect control message.

After receiving the effect control message sent by the DMC, each DMR controls the play effect of the to-be-played media file according to the effect control message. In this embodiment, the DMC performs, by using commands such as RCS:: (SetVolume, SetBrightness), uniform control over a play rendering effect of the media file played on each DMR, for example, sets volume and sets brightness of a picture.

In addition, in this embodiment, the DMC may further repeat or play, by using AVT::SetAVTransportURI and AVT::Play, other media content that can be played.

Persons of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes any medium that can store program code, such as a read-only memory (ROM), a random-access memory (RAM), a magnetic disk, or an optical disc.

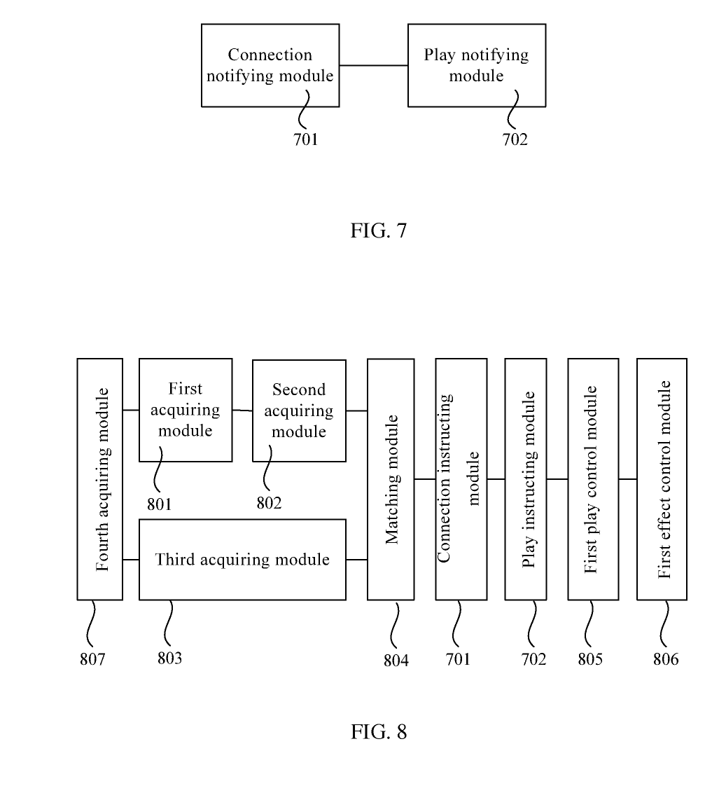

FIG. 7 is a schematic structural diagram of a first embodiment of a media controller according to the present invention. As shown in FIG. 7, this embodiment provides a media controller, which may execute each step in the foregoing first method embodiment, where each step in the foregoing first method embodiment is not repeatedly described herein. The media controller provided by this embodiment may include a connection instructing module 701 and a play instructing module 702. The connection instructing module 701 is configured to separately send a connection preparation message to a media server and at least one media renderer that supports multicast, so as to instruct the media server and each media renderer to configure a multicast protocol address according to the connection preparation message. The play instructing module 702 is configured to send a media transport identifier and a play message to the media server, so as to instruct the media server to transmit, on the multicast protocol address according to the play message, a media stream of a to-be-played media file identified by the media transport identifier, so that each media renderer receives the media stream on the multicast protocol address and plays the to-be-played media file locally.

FIG. 8 is a schematic structural diagram of a second embodiment of a media controller according to the present invention. As shown in FIG. 8, this embodiment provides a media controller, which may execute each step in the foregoing fourth method embodiment, where each step in the foregoing fourth method embodiment is not repeatedly described herein. On the basis shown in the foregoing FIG. 7, the media controller provided by this embodiment may further include a first acquiring module 801, a second acquiring module 802, a third acquiring module 803, and a matching module 804. The first acquiring module 801 is configured to acquire, from a media information base of the media server, a media information list of a media file available for selection by a user, where each media information entry in the media information list includes a media transport protocol and a media format of each media file. The second acquiring module 802 is configured to acquire a media transport protocol and a media format of the to-be-played media file according to the media information list. The third acquiring module 803 is configured to acquire, according to a media renderer list of at least one media renderer selected by the user, a multicast-based media transport protocol and media format that are supported by each media renderer. The matching module 804 is configured to match the media transport protocol and the media format of the to-be-played media file with the multicast-based media transport protocol and media format that are supported by each media renderer to obtain a multicast-based media transport protocol and media format that are supported by the media server and each media renderer, and acquire the at least one media renderer supporting multicast.

Further, the media controller provided by this embodiment may further include a first play control module 805 and a first effect control module 806. The first play control module 805 is configured to send a play control message to the media server, so that the media server controls a play process of the to-be-played media file according to the play control message. The first effect control module 806 is configured to send an effect control message to each media renderer, so that each media renderer controls a play effect of the to-be-played media file according to the effect control message.

Further, the media controller provided by this embodiment may further include a fourth acquiring module 807. The fourth acquiring module 807 is configured to acquire device information of the media server and the media renderer through a device automatic discovery process, where the device information includes service information of all services that are supported by the media server and the media renderer. Services supported by the media server include a content directory service, a connection management service, and an audio video transport service, and a service supported by the media renderer includes a connection management service.

This embodiment provides a media controller, which separately sends a connection preparation message to a media server and at least one media renderer, so that the media server and each media renderer configure a multicast protocol address, and then sends a media transport identifier and a play message to the media server, so as to instruct the media server to transmit, on the multicast protocol address, a media stream of a to-be-played media file, so that each media renderer receives the media stream on the multicast protocol address and plays the to-be-played media file locally. This embodiment implements synchronous playing, by multiple players, of same media content, without the need of using a manner of requesting by multiple media players one by one, thereby causing no waste of resources.

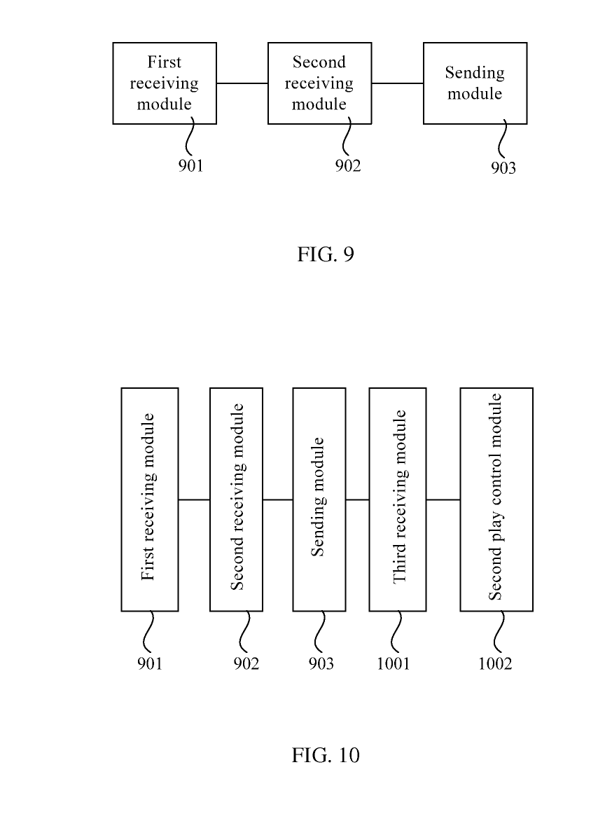

FIG. 9 is a schematic structural diagram of a first embodiment of a media server according to the present invention. As shown in FIG. 9, this embodiment provides a media server, which may execute each step in the foregoing second method embodiment, where each step in the foregoing second method embodiment is not repeatedly described herein. The media server provided by this embodiment may include a first receiving module 901, a second receiving module 902, and a sending module 903. The first receiving module 901 is configured to receive a connection preparation message sent by a media controller, and configure a multicast protocol address according to the connection preparation message. The second receiving module 902 is configured to receive a media transport identifier and a play message that are sent by the media controller. The sending module 903 is configured to transmit, on the multicast protocol address according to the play message, a media stream of a to-be-played media file identified by the media transport identifier, so that at least one media renderer supporting multicast separately receives the media stream on the multicast protocol address and plays the to-be-played media file locally.

FIG. 10 is a schematic structural diagram of a second embodiment of a media server according to the present invention. As shown in FIG. 10, this embodiment provides a media server, which may execute each step in the foregoing fourth method embodiment, where each step in the foregoing fourth method embodiment is not repeatedly described herein. On the basis shown in the foregoing FIG. 9, the media server provided by this embodiment may further include a third receiving module 1001 and a second play control module 1002. The third receiving module 1001 is configured to receive a play control message sent by the media controller. The second play control module 1002 is configured to control play progress and a play speed of the to-be-played media file according to the play control message.

This embodiment provides a media server, which configures a multicast protocol address according to a received connection preparation message and transmits a media stream of a to-be-played media file on the multicast protocol address according to a received play message, so that each media renderer receives the media stream on the multicast protocol address and plays the to-be-played media file locally. This embodiment implements synchronous playing, by multiple players, of same media content, without the need of using a manner of requesting by multiple media players one by one, thereby causing no waste of resources.

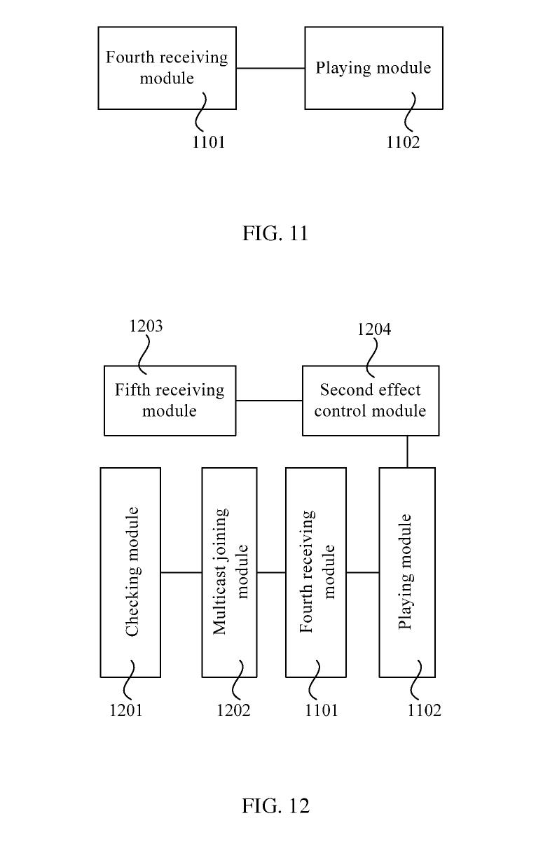

FIG. 11 is a schematic structural diagram of a first embodiment of a media renderer according to the present invention. As shown in FIG. 11, this embodiment provides a media renderer, which may execute each step in the foregoing third method embodiment, where each step in the foregoing third method embodiment is not repeatedly described herein. The media renderer provided by this embodiment may include a fourth receiving module 1101 and a playing module 1102. The fourth receiving module 1101 is configured to receive a connection preparation message sent by a media controller, and configure a multicast protocol address according to the connection preparation message. The playing module 1102 is configured to receive a media stream of a to-be-played media file on the multicast protocol address and play the to-be-played media file locally, where the media stream of the to-be-played media file is transmitted on the multicast protocol address after a media server receives a media transport identifier and a play message that are sent by the media controller, and the to-be-played media file is identified by the media transport identifier.

FIG. 12 is a schematic structural diagram of a second embodiment of a media renderer according to the present invention. As shown in FIG. 12, this embodiment provides a media renderer, which may execute each step in the foregoing fourth method embodiment, where each step in the foregoing fourth method embodiment is not repeatedly described herein. On the basis shown in the foregoing FIG. 11, the media renderer provided by this embodiment may further include a checking module 1201 and a multicast joining module 1202. The checking module 1201 is configured to check, after the connection preparation message is received, whether a media transport protocol of the media server, which is acquired by the media controller, is a multicast media transport protocol. The multicast joining module 1202 is configured to join, if the media transport protocol of the media server is the multicast media transport protocol, a multicast address group identified by the multicast protocol address.

Further, the media renderer provided by this embodiment may further include a fifth receiving module 1203 and a second effect control module 1204. The fifth receiving module 1203 is configured to receive an effect control message sent by the media controller. The second effect control module 1204 is configured to control a play effect of the to-be-played media file according to the effect control message.

This embodiment provides a media renderer, which configures a multicast protocol address according to a received connection preparation message, receives a media stream of a to-be-played media file on the multicast protocol address, and plays the to-be-played media file locally, where the media stream of the to-be-played media file is transmitted on the multicast protocol address after a media server receives a media transport identifier and a play message that are sent by a media controller, and the to-be-played media file is identified by the media transport identifier. This embodiment implements synchronous playing, by multiple players, of same media content, without the need of using a manner of requesting by multiple media players one by one, thereby causing no waste of resources.

This embodiment further provides a media player, which may include the media controller shown in the foregoing FIG. 7 or FIG. 8 and the media renderer shown in the foregoing FIG. 11 or FIG. 12.

This embodiment further provides a media playing system, which may include the media controller shown in the foregoing FIG. 7 or FIG. 8, the media server shown in the foregoing FIG. 9 or FIG. 10, and at least one media renderer shown in the foregoing FIG. 11 or FIG. 12.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A media playing method, comprising:
separately sending a connection preparation message to a media server and at least one media renderer that supports multicast to instruct the media server and each media renderer to configure a multicast protocol address according to the connection preparation message; and
sending a media transport identifier and a play message to the media server to instruct the media server to transmit, on the multicast protocol address according to the play message, a media stream of a to-be-played media file identified by the media transport identifier such that each media renderer receives the media stream on the multicast protocol address and plays the to-be-played media file locally.

2. The method according to claim 1, further comprising:
acquiring, from a media information base of the media server, a media information list of a media file available for selection by a user, wherein each media information entry in the media information list comprises a media transport protocol and a media format of each media file;
acquiring a media transport protocol and a media format of the to-be-played media file according to the media information list;
acquiring, according to a media renderer list of at least one media renderer selected by the user, a multicast-based media transport protocol and media format that are supported by each media renderer;
matching the media transport protocol and the media format of the to-be-played media file with the multicast-based media transport protocol and media format that are supported by each media renderer to obtain a multicast-based media transport protocol and media format that are supported by the media server and each media renderer; and
acquiring the at least one media renderer supporting multicast.

3. The method according to claim 1, further comprising:
sending a play control message to the media server such that the media server controls a play process of the to-be-played media file according to the play control message; and
sending an effect control message to each media renderer such that each media renderer controls a play effect of the to-be-played media file according to the effect control message.

4. The method according to claim 1, further comprising acquiring device information of the media server and the media renderer through a device automatic discovery process, wherein the device information comprises service information of all services that are supported by the media server and the media renderer, and wherein services supported by the media server comprise a content directory service, a connection management service, and an audio video transport service, and a service supported by the media renderer comprises a connection management service.

5. A media playing method, comprising:
receiving a connection preparation message sent by a media controller;
configuring a multicast protocol address according to the connection preparation message;
receiving a media transport identifier and a play message that are sent by the media controller; and
transmitting, on the multicast protocol address according to the play message, a media stream of a to-be-played media file identified by the media transport identifier such that at least one media renderer supporting multicast separately receives the media stream on the multicast protocol address and plays the to-be-played media file locally.

6. The method according to claim 5, further comprising:
receiving a play control message sent by the media controller; and
controlling play progress and a play speed of the to-be-played media file according to the play control message.

7. A media playing method, comprising:
receiving a connection preparation message sent by a media controller;
configuring a multicast protocol address according to the connection preparation message;
receiving a media stream of a to-be-played media file on the multicast protocol address; and
playing the to-be-played media file locally,
wherein the media stream of the to-be-played media file is transmitted on the multicast protocol address after a media server receives a media transport identifier and a play message that are sent by the media controller, and the to-be-played media file is identified by the media transport identifier.

8. The method according to claim 7, further comprising:
checking whether a media transport protocol of the media server, which is acquired by the media controller, is a multicast-based media transport protocol after the connection preparation message is received; and
joining a multicast group identified by the multicast protocol address when the media transport protocol of the media server is the multicast media transport protocol.

9. The method according to claim 7, further comprising:
receiving an effect control message sent by the media controller; and
controlling a play effect of the to-be-played media file according to the effect control message.

10. A media controller, comprising:
a connection instructing module configured to separately send a connection preparation message to a media server and at least one media renderer that supports multicast to instruct the media server and each media renderer to configure a multicast protocol address according to the connection preparation message; and
a play instructing module configured to send a media transport identifier and a play message to the media server to instruct the media server to transmit, on the multicast protocol address according to the play message, a media stream of a to-be-played media file identified by the media transport identifier such that each media renderer receives the media stream on the multicast protocol address and plays the to-be-played media file locally.

11. The controller according to claim 10, further comprising:
a first acquiring module configured to acquire, from a media information base of the media server, a media information list of a media file available for selection by a user, wherein each media information entry in the media information list comprises a media transport protocol and a media format of each media file;
a second acquiring module configured to acquire a media transport protocol and a media format of the to-be-played media file according to the media information list;
a third acquiring module configured to acquire, according to a media renderer list of at least one media renderer selected by the user, a multicast-based media transport protocol and media format that are supported by each media renderer; and
a matching module configured to match the media transport protocol and the media format of the to-be-played media file with the multicast-based media transport protocol and media format that are supported by each media renderer to obtain a multicast-based media transport protocol and media format supported by the media server and each media renderer, and acquire the at least one media renderer supporting multicast.

12. The controller according to claim 10, further comprising:
a first play control module configured to send a play control message to the media server such that the media server controls a play process of the to-be-played media file according to the play control message; and
a first effect control module configured to send an effect control message to each media renderer such that each media renderer controls a play effect of the to-be-played media file according to the effect control message.

13. The controller according to claim 10, further comprising a fourth acquiring module configured to acquire device information of the media server and the media renderer through a device automatic discovery process, wherein the device information comprises service information of all services that are supported by the media server and the media renderer, and wherein services supported by the media server comprise a content directory service, a connection management service, and an audio video transport service, and a service supported by the media renderer comprises a connection management service.

14. A media server, comprising:
a first receiving module configured to receive a connection preparation message sent by a media controller, and configure a multicast protocol address according to the connection preparation message;
a second receiving module configured to receive a media transport identifier and a play message that are sent by the media controller; and
a sending module configured to transmit, on the multicast protocol address according to the play message, a media stream of a to-be-played media file identified by the media transport identifier such that at least one media renderer supporting multicast separately receives the media stream on the multicast protocol address and plays the to-be-played media file locally.

15. The server according to claim 14, further comprising:
a third receiving module configured to receive a play control message sent by the media controller; and
a second play control module configured to control play progress and a play speed of the to-be-played media file according to the play control message.

16. A media renderer, comprising:
a fourth receiving module configured to receive a connection preparation message sent by a media controller, and configure a multicast protocol address according to the connection preparation message; and
a playing module configured to receive a media stream of a to-be-played media file on the multicast protocol address, and play the to-be-played media file locally,
wherein the media stream of the to-be-played media file is transmitted on the multicast protocol address after a media server receives a media transport identifier and a play message that are sent by the media controller, and the to-be-played media file is identified by the media transport identifier.

17. The renderer according to claim 16, further comprising:
a checking module configured to check, after the connection preparation message is received, whether a media transport protocol of the media server, which is acquired by the media controller, is a multicast media transport protocol; and
a multicast joining module configured to join a multicast address group identified by the multicast protocol address when the media transport protocol of the media server is the multicast media transport protocol.

18. The renderer according to claim 16, further comprising:
a fifth receiving module configured to receive an effect control message sent by the media controller; and
a second effect control module configured to control a play effect of the to-be-played media file according to the effect control message.
